(19) United States
(12) Patent Application Publication
(10) Pub. No.: US 2018/0273244 A1
(43) Pub. Date: Sep. 27, 2018

(54) MULTIFUNCTIONAL CONTAINER WITH SEQUENTIAL RECEPTACLES DISPOSED THEREIN

(71) Applicant: Nadezhda Ausfresser, Roswell, GA (US)

(72) Inventor: Nadezhda Ausfresser, Roswell, GA (US)

(21) Appl. No.: 15/469,436

(22) Filed: Mar. 24, 2017

(51) Int. Cl. B65D 21/02; B65D 83/08; B65F 1/00; A47K 10/46; A47K 10/42

(52) U.S. Cl. CPC B65D 21/0204; B65D 83/0805; A47K 10/421; A47K 10/46; B65F 1/0006

(57) ABSTRACT

A container has a first container having a hollow interior defined by a base, a top, and a plurality of sidewalls extending there between. A second container attached to the first container. The second container comprises a plurality of collapsible receptacles disposed therein in sequential order, wherein the plurality of collapsible receptacles have an opening; and an aperture extending into an interior of the second container, wherein a perimeter of the opening is removeably attached to the aperture, wherein the aperture retains the opening in an open position.

### CROSS-REFERENCE TO RELATED APPLICATION(S)

Not applicable

### BACKGROUND OF THE INVENTION

### 1. Field of Invention

The present invention relates to the field of container and more particularly to multifunctional container systems.

### 2. Description of Related Art

Convenience has been a constant driving force in the evolution of consumer based technologies. Accordingly, devices are continuously being developed to address issues relating to the improvement of availability and function for their daily use. Where a device improves convenience and hygiene or health, it can have global implications. One prime example of such a device is sequential tissue dispensers. Kleenex has become a household name due to their container having individual tissues that are pulled from the container and automatically present subsequent tissues for later use. While convenient, there is a substantial void relating to the disposal of these tissues.

Whether it is tissue or some other material that is meant to be disposable, the dispensing units are relatively common and predicated on the idea that a trash receptacle would not be difficult to find. Other examples of products presenting the same void would be paper towels, disposable medical supplies, mechanics rags, etc. All of these disposable products have a dispensing unit that allows for convenient access to the product with a complete disregard as to the inevitable need for a refuse container.

Such a problem results in extreme damage to our global environment and ecosystem as well as presenting major public sanitation issues related to littering. When a user requires a tissue to remove leakage of bodily fluid, there is no incentive outside of a slight moral obligation to retain the used tissue, with the bodily fluid, until a trash receptacle is found. Where the tissue is used in a remote location or during a long car ride, the used tissue is often discarded out into the environment. While the damage to the ecosystem is obvious, where bodily fluid contacts other organisms there is a high risk for the spread of disease.

Currently, aside from finding a traditional trash or refuse receptacle, people are required to bring something to store used tissue, such as a bag or a pocket of a garment they are wearing. This does not solve any of the issues relating to the immediate need to discard these disposable products.

Based on the foregoing, there is a need in the art for a device that will provide a convenient solution for a user to be able to discard disposable products without having to store the disposable products until a traditional trash receptacle is found.

### SUMMARY OF THE INVENTION

A container comprises a first container having a hollow interior defined by a base, a top, and a plurality of sidewalls extending there between; and a second container attached to the first container. The second container comprises a plurality of collapsible receptacles disposed therein in sequential order, wherein the plurality of collapsible receptacles have an opening; and an aperture extending into an interior of the second container, wherein a perimeter of the opening is removeably attached to the aperture, wherein the aperture retains the opening in an open position.

In an embodiment, the second container is releasably attached to the first container, wherein a first attachment means is disposed on an exterior surface of the first container, and wherein a second attachment means is disposed on an exterior of the second container, wherein the first attachment means and the second attachment means are in communication with each other.

In an embodiment, the first attachment means is a hook, and therein the second attachment means is a loop.

In an embodiment, the first attachment means comprises an trapezoidal indented channel, and wherein the second attachment means is a trapezoidal protrusion.

In an embodiment, the first attachment means is a threaded indentation, and therein the second attachment means is a threaded protrusion, wherein the second attachment means is rotated into the first attachment means.

In an embodiment, the plurality of receptacles are configured to receive bio hazardous materials.

In an embodiment, the plurality of receptacles receives one or more used materials from the first container.

In an embodiment, the plurality of receptacles receives the one or more used materials through a method comprising the steps of: attaching the second container to the first container, wherein the second attachment means engages the first attachment means; then removing the one or more materials from the first container; then using the one or more materials removed from the first container; then discarding the one or more used materials into one of the plurality of receptacles, wherein a first receptacle is attached to the aperture, wherein if the first receptacle is full the method further comprises the step of removing the first receptacle, wherein a subsequent receptacle replaces the first receptacle.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a perspective view of the multifunctional container, according to an embodiment of the present invention;

FIG. 2 is a perspective view of the multifunctional container, according to an embodiment of the present invention;

FIG. 3 is a perspective view of the multifunctional container, according to an embodiment of the present invention;

### DETAILED DESCRIPTION OF PREFERRED EMBODIMENTS

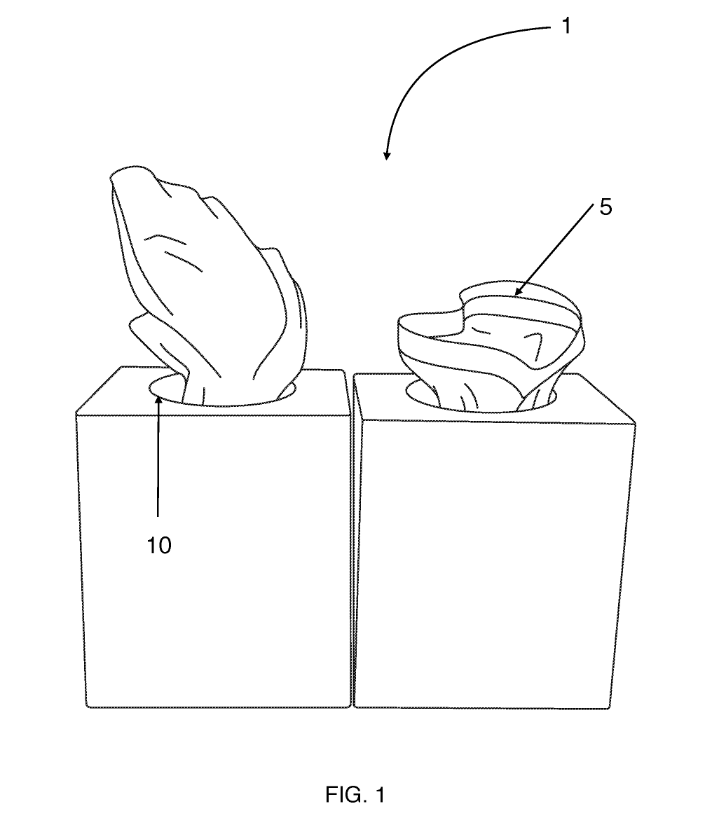

Preferred embodiments of the present invention and their advantages may be understood by referring to FIGS. 1-3, wherein like reference numerals refer to like elements.

FIG. 1 illustrates a multifunctional container 1 with sequential receptacles 5 disposed therein has a container component defined by a base and a top separated by one or more sidewalls. The container has a hollow interior with at least one aperture 10 extending through at least the top, base, or one or more sidewalls. A plurality of receptacles, each having an opening to a hollow interior defined by at least a first side and a second side, are disposed within the container.

The opening of each of the plurality of receptacles 5 is aligned with the aperture 10 of the container such that an opening of an initial receptacle engages the aperture holding the initial receptacle in place within the container 1. The opening and the aperture engage one another such that the opening is retained in an open position while the initial receptacle is within the container.

Each of the plurality of receptacles are disposed in a sequential order relative to one another. For example, the first side and second side of the initial receptacle define a body of the initial receptacle. The body of the initial receptacle is disposed entirely within a second receptacle, wherein the body of the second receptacle is disposed within a third receptacle. Such a configuration continues until a desired amount of receptacles are disposed within one another in this sequential order.

The opening of each of the receptacles may be resilient whereby the opening is further defined by a retractable material that positively engages a lip on the aperture of the container. In this way, the retractable opening can be removed from the lip of the container and that receptacle removed from the container while a subsequent receptacle is simultaneously pulled into position whereby the resilient opening of the subsequent receptacle replaces the positive engagement of the removed receptacle. When the removed receptacle is no longer engaging the container, the resilient material retracts into a closed position effectively sealing the contents of the removed receptacle therein.

The opening of each of the receptacles may be sealable whereby when an initial receptacle is removed from the container, a user then seals the receptacle and encloses the contents therein.

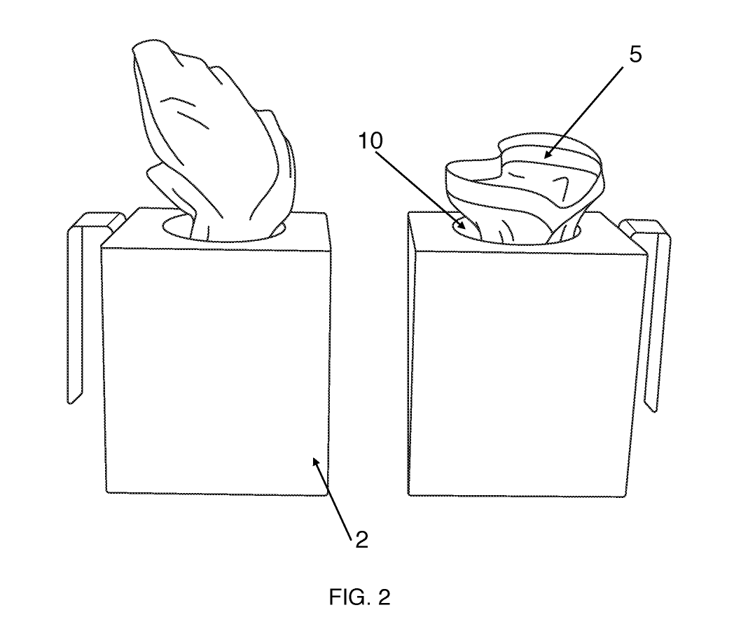

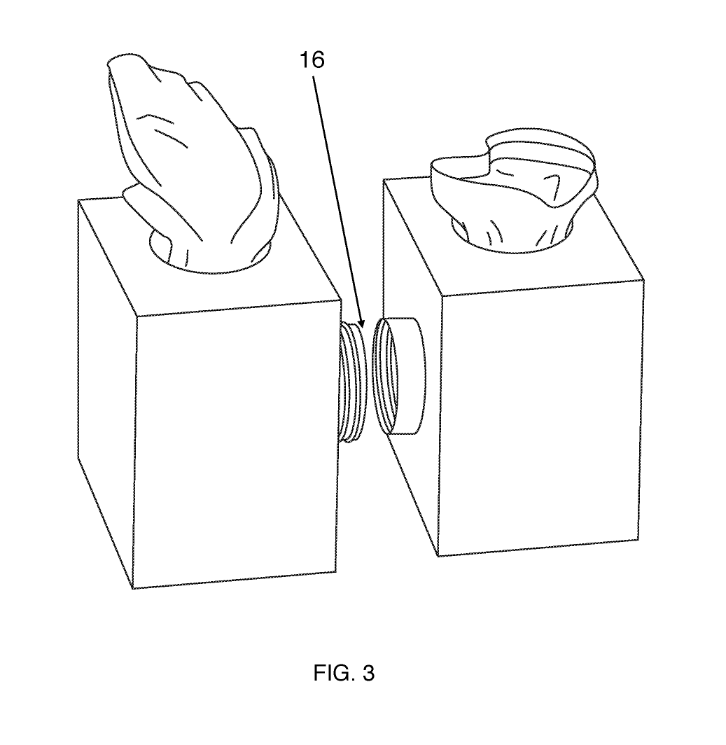

FIGS. 2-3 illustrated that the container 1 may further have an attachment means 15 disposed on an exterior surface of at least the base, top, or one or more sidewalls. The attachment means provides for a positive engagement between the container and another surface. Examples of the attachment means are a hook a loop attachment mechanism, friction attachment mechanisms, corresponding protrusion attachments, magnetic attachments, or a threading attachment means 16. The hook and loop attachment would have either the hook or loop on the container with the other component disposed on an exterior surface such that the container is releasbly engaged. Corresponding protrusion attachments may provide for a key or channel type engagement wherein the container has either a key or a channel disposed on one or the sides, base, or top and a second surface having the corresponding attachment component configured to accept the key or channel. Magnetic attachments are disposed on or within the container such that the container is releasably attachable to a ferromagnetic surface. The threading attachment means provides for a protruding helically threaded attachment extending outward from the one or more sidewalls and a second container or surface having a correspondingly threaded indentation configured to accept the container as the helically threaded attachment is rotated into the indentation.

The other surface connecting to the container 1 may be a second container 2 having one or more disposable materials therein. The second container 2 has a corresponding attachment means for engagement with the attachment means of the multifunctional container. For example, the multifunctional container with the plurality of receptacles 5 is attached to a second container having disposable tissues. When a tissue is removed from the second container and used, the multifunctional container is immediately available as the user can dispose of the used tissue in the initial receptacle.

Considering specific applications of the plurality of receptacles, each of the plurality of receptacles is composed of specific materials such as puncture resistant material, non-reactive material, ultra-violate light prohibitive material, and other depending on the specific item being disposed of. In a medical application, disposable materials may include ear specula or tongue depressors. As these materials are used to contact a patient, they are considered bio hazardous and require dispose in an appropriate container of appropriate material. For this example, each of the receptacles is configured to receive such bio hazardous materials.

In use, the plurality of receptacles are predisposed within the container or the user inserts an amount of sequentially engaged receptacles through the aperture and attaches the initial receptacle to the aperture. One or more disposable materials are used from a secondary source or second container attached to the multifunction container. When the user is ready to discard the used disposable material it is inserted through the opening of the initial receptacle. The process, at this point, is repeated until the initial receptacle is determined to be full of used disposable material. After the user makes such a determination, the opening of the initial receptacle is disengaged from the aperture and the user pulls the initial receptacle from the container through the aperture. The opening of the second receptacle follows the travel of the initial receptacle, as it is removed until the opening of the second receptacle breaches the aperture. Once the opening of the second receptacle has breached the aperture, it releases the initial and now removed receptacle. The user then ensures a positive engagement between the opening of the second, and now initial receptacle, as the second receptacle has taken the position of the removed receptacle and is ready to receive used disposable material.

An additional step is provided where the opening of each receptacle requires attachment to the container. If the opening of each receptacle is resilient, it will automatically retract in a locked position around the lip of the container. If the opening of each of the receptacles has an additional clip or attachment means, the user must ensure the attachment means is positively engaging the aperture of the container.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A container comprising:
a. a first container having a hollow interior defined by a base, a top, and a plurality of sidewalls extending there between; and
b. a second container attached to the first container, the second container comprising:
i. a plurality of collapsible receptacles disposed therein in sequential order, wherein the plurality of collapsible receptacles have an opening; and
ii. an aperture extending into an interior of the second container, wherein a perimeter of the opening is removeably attached to the aperture, wherein the aperture retains the opening in an open position.

2. The container of claim 1, wherein the second container is releasably attached to the first container, wherein a first attachment means is disposed on an exterior surface of the first container, and wherein a second attachment means is disposed on an exterior of the second container, wherein the first attachment means and the second attachment means are in communication with each other.

3. The container of claim 2, wherein the first attachment means is a hook, and therein the second attachment means is a loop.

4. The container of claim 2, wherein the first attachment means comprises an trapezoidal indented channel, and wherein the second attachment means is a trapezoidal protrusion.

5. The container of claim 2, wherein the first attachment means is a threaded indentation, and therein the second attachment means is a threaded protrusion, wherein the second attachment means is rotated into the first attachment means.

6. The container of claim 1, wherein the plurality of receptacles are configured to receive bio hazardous materials.

7. The container of claim 2, wherein the plurality of receptacles receives one or more used materials from the first container.

8. The container of claim 7, wherein the plurality of receptacles receives the one or more used materials through a method comprising the steps of:
a. attaching the second container to the first container, wherein the second attachment means engages the first attachment means;
b. removing the one or more materials from the first container;
c. using the one or more materials removed from the first container;
d. discarding the one or more used materials into one of the plurality of receptacles, wherein a first receptacle is attached to the aperture, wherein if the first receptacle is full the method further comprises the step of removing the first receptacle, wherein a subsequent receptacle replaces the first receptacle.
